(19) United States
(12) Patent Application Publication
(10) Pub. No.: US 2016/0107010 A1
(43) Pub. Date: Apr. 21, 2016

(54) FIRE SUPPRESSION PACKAGING

(71) Applicant: GelTech Solutions, Inc., Jupiter, FL (US)

(72) Inventor: Peter Cordani, Palm Beach Gardens, FL (US)

(21) Appl. No.: 14/682,542

(22) Filed: Apr. 9, 2015

Related U.S. Application Data
(63) Continuation-in-part of application No. 14/620,925, filed on Feb. 12, 2015.
(60) Provisional application No. 62/064,011, filed on Oct. 15, 2014.

(51) Int. Cl. A62C 3/00; B65D 75/30; A62D 1/00; B65D 65/38

(52) U.S. Cl. CPC A62C 3/00; B65D 65/38; B65D 75/30; A62D 1/0035; B65D 2575/586

(57) ABSTRACT

A method and devices for suppressing a fire within a receptacle. The device includes a receptacle containing an admixture of super absorbent polymer and water having substantially superior fire suppression and extinguishing properties at a level that is not electrically conductive. When used with lithium batteries, once a battery is placed within the receptacle should arcing or a buildup of heat occur, the receptacle will rupture and the admixture will cover the specific area. These particular properties and ratios of the admixture will enable a fire to be extinguished rapidly and not flare back up. The admixture further encapsulates noxious and toxic gases associated with a fire. A mesh or tin foil can be placed around the battery to suppress explosions.

### PRIORITY CLAIM

In accordance with 37 C.F.R. 1.76, a claim of priority is included in an Application Data Sheet filed concurrently herewith. Accordingly, the present invention is a Continuation-In-Part application and claims priority to U.S. application Ser. No. 14/620,925, entitled “FIRE SUPPRESSION PACKAGING AND METHOD OF MANUFACTURE”, filed Feb. 12, 2015 which claims priority to U.S. Provisional Patent Application No. 62/064,011, entitled “BATTERY STORAGE DEVICE AND METHOD OF MANUFACTURE”, filed Oct. 15, 2014. The contents of which the above referenced application is incorporated herein by reference.

### FIELD OF THE INVENTION

This invention relates to the field of fire prevention, and more particularly to casings and packaging of electronics, and other potential fire hazardous goods. The casings and packaging devices contain a hydrated amount of super absorbent polymer constructed and arranged to arrest and extinguish an electrical fire.

### BACKGROUND OF THE INVENTION

As of Jan. 1, 2008, the Department of Transportation (DOT) through the Pipeline and Hazardous Materials Safety Administration (PHMSA) prohibits loose lithium batteries in checked baggage. PHMSA develops and enforces regulations for the safe, reliable, and environmentally sound operation of the nation's pipeline transportation.

Current tips for safe travel with batteries includes, but is not limited to, keeping batteries in the cabin of the airplane versus storage in checked baggage with the reasoning that the flight crew can better monitor conditions and have access to the batteries if a fire does occur; purchasing batteries from reputable sources since substandard counterfeits are more likely to malfunction and cause a fire; avoid carrying recalled or damaged batteries on the aircraft; insulate the battery terminals from contact with other batteries and metal; prohibit batteries from coming in contact with metal objects, such as coins, keys, or jewelry; and place each battery in its own protective case, plastic bag, or package.

The Federal Aviation Administration has studied fire hazards associated with both primary and lithium-ion cells and no longer allows large, palletized shipments of these batteries to be transported as cargo on passenger aircraft. The FAA research states that an explosion will not result from shorting or damaging either lithium-ion or primary lithium batteries but both types of batteries are extremely flammable. Primary lithium batteries cannot be extinguished with firefighting agents normally carried on aircraft, whereas lithium-ion batteries can be extinguished by most common extinguishing agents, including those commonly carried on board commercial aircraft.

Lithium metal batteries, including non-rechargeable lithium and primary lithium are often used with cameras and other small personal electronics. Consumer-sized batteries (up to 2 grams of lithium per battery) are typically found in non-rechargeable batteries used for personal film cameras and digital cameras, as well as the flat round lithium button cells sometimes used for calculators. Lithium ion batteries (including rechargeable lithium, lithium polymer, LIPO, secondary lithium) are allowed on a plane but within limits. Passengers may carry consumer-sized lithium ion batteries with no more than 8 grams of equivalent lithium content or 100 watt-hours of power per battery. This size covers AA, AAA, 9-volt, cell phone, PDA, camera, handheld game, standard laptop computer batteries, and camcorder batteries. Passengers can also bring up to two larger lithium ion batteries that contain between 8 and 25 grams of equivalent lithium content per battery in their carry-on luggage. Despite the fact that lithium based batteries are allowed in small quantities on airplanes, the reality is that lithium is a fire hazard and the allowance of the batteries on an airplane is based upon the assumption that the battery was manufactured properly and in good condition. Further, passengers may unknowingly exceed the guidelines. The fire issue is not limited to passenger planes as most every commercial carrier, e.g. Federal Express, UPS and the like are known to transport batteries. The potential fire hazard is a threat to the remainder of the cargo and the individuals that are handling the transportation of the batteries.

### SUMMARY OF THE INVENTION

Disclosed is a packaging material for extinguishing and suppressing the potential threat of a fire arising during the storage or shipping of materials which can overheat resulting in a fire e.g. lithium batteries, electronic components, etc., or for the storage and transport of any material that poses a risk of a fire. The packaging includes an admixture of a hydrated super absorbent polymer having an amount capable of fire suppression and extinguishing of fires. The packaging, when formed as a receptacle, receives the battery or some instances the entire electronic device housing the battery. Should an arcing occur the packaging will release the admixture to extinguish the battery fire. The admixture is used to saturate the immediate area around the battery further providing a benefit of cooling down the battery. The admixture viscosity inhibits flowing to adjacent areas and is non-conductive. The properties of the admixture inhibit a restart of a battery fire and when in contact with an electrical fire is capable of encapsulating noxious and toxic gases produced by the electrical fire. The packaging can also be molded into casings or shells which are fitted onto an object to protect against potential fire risks, e.g. laptop computer shell, phone casing, tablet computer casing, battery casings, and the like.

Accordingly, it is an objective of the present invention to provide packaging for an admixture of non-conductive hydrated super absorbent polymer for extinguishment of fires during the transport and storage of objects that pose a risk of causing a fire, e.g. lithium batteries, computers, tablets etc. The packaging can be in various forms, including corrugated cardboard boxes having the hydrated super absorbent polymer disposed within the ribs and spines of the corrugation. In this aspect, the surfaces of the ribs and spines of the corrugations can be coated with water-resistant or water proof lining so as to maintain the hydrated super absorbent polymer without leakage into the contents. Alternatively, the inserts can be manufactured to fit into the hollow areas of the corrugations. In one embodiment, the internal walls of the boxes facing the interior can be lined with sheets of the insert wherein the sheets comprise cavities containing the hydrated super absorbent polymer. The layer can be blistered, smooth, similar to a gel pack but dimensioned to fit within the exterior of the interior walls of the storing container. In other embodiments, rods or tubes containing the hydrated super absorbent polymer can be placed into the box. In other embodiments, the hydrated super absorbent polymer is contained within packaging “peanuts” or packaging “popcorn”. In another embodiment, the box may contain an inner lining comprising a hydrated super absorbent polymer. The contents can optionally be sealed under positive or negative pressure. The packaging containing the hydrated super absorbent polymer can be of any shape or dimension, e.g. rods, pads, sheets, bubbles, and the like.

It is also an objective of the present invention to provide casings or shells for an object which poses a risk for igniting into flames or overheating e.g. laptop, PC, tablet, phone to protect against potential fire risks.

It is an objective of the present invention to provide packaging for an admixture of non-conductive hydrated super absorbent polymer for extinguishment of battery fires.

It is another objective of the present invention to provide a receptacle for placement of lithium batteries during storage and shipping.

Still another objective of the present invention is to provide a receptacle for use in storage, shipment and recharging of electronic components such as laptops and tablets operating on lithium batteries having a barrier placement of hydrated super absorbent polymer for extinguishment of a battery fire should arcing occur.

It is a further objective of the present invention to provide a method of forming a battery storage receptacle that can be reused for storage, shipping and during battery recharging.

Still another objective of the present invention is to provide a fire extinguisher receptacle for batteries or associated electronic items that, if leaking, leaves a residual that can be removed by vacuuming when dried.

It is still yet another objective of the present invention to provide a receptacle to work with a unique admixture of super absorbent polymer and water which has viscosity that will retain a shape for a period of time. The viscosity also enables the admixture to adhere to horizontal, vertical, inclined, and on curved surfaces.

Still another objective of the invention is provide packaging that resembles bubble wrap wherein a portion, or all, bubbles are filled with a fire suppression admixture.

Other objectives and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1A is a pictorial view of a large fire suppression receptacle;

FIG. 1B is a pictorial view of a mid-size fire suppression receptacle;

FIG. 1C is a pictorial view of a small fire suppression receptacle;

FIG. 2A is a side view of FIG. 1C;

FIG. 2B is a side view of FIG. 1B;

FIG. 2C is a side view of FIG. 1A;

FIG. 3A is a pictorial view of a corrugated box for receipt of an insert or fire extinguishing admixture;

FIG. 3B is an exploded view of the layers of corrugation as shown in FIG. 3A.

FIG. 4 pictorial view of a single layer corrugated box for receipt of an insert or fire extinguishing admixture;

FIG. 5A is a pictorial view of a box with partitions, the insert being shaped and dimensioned to line the partitions, base and/or lid of the box;

FIG. 5B is an exploded view of the partitions shown in FIG. 5A.

FIG. 6A is a perspective view of a banker's box receptacle;

FIG. 6B is a second embodiment of a banker's box receptacle;

FIG. 7 is perspective view of a sheet having a plurality of sealed pouches containing the fire extinguishing admixture;

FIG. 8A is a side view of a casing.

FIG. 8B is a front view of a casing adapted to a tablet;

FIG. 8C is a front view of a casing adapted to a telephone;

FIG. 8D is a side view of a casing adapted to a laptop computer.

### DETAILED DESCRIPTION OF THE INVENTION

While the present invention is susceptible of embodiment in various forms, there is shown in the drawings and will hereinafter be described a presently preferred, albeit not limiting, embodiment with the understanding that the present disclosure is to be considered an exemplification of the present invention and is not intended to limit the invention to the specific embodiments illustrated.

Definitions

The terminology used herein is for the purpose of describing particular embodiments only and is not intended to be limiting of the invention. As used herein, the singular fauns “a”, “an” and “the” are intended to include the plural forms as well, unless the context clearly indicates otherwise. Furthermore, to the extent that the terms “including”, “includes”, “having”, “has”, “with”, or variants thereof are used in either the detailed description and/or the claims, such terms are intended to be inclusive in a manner similar to the term “comprising.”

As used in this specification and the appended claims, the term “or” is generally employed in its sense including “and/or” unless the content clearly dictates otherwise.

The term “about” or “approximately” means within an acceptable error range for the particular value as determined by one of ordinary skill in the art, which will depend in part on how the value is measured or determined, i.e., the limitations of the measurement system. For example, “about” can mean within 1 or more than 1 standard deviation, per the practice in the art. Alternatively, “about” can mean a range of up to 20%, up to 10%, up to 5%, or up to 1% of a given value or range. Alternatively, the term can mean within an order of magnitude, preferably within 5-fold, and also preferably within 2-fold, of a value. Where particular values are described in the application and claims, unless otherwise stated the term “about” meaning within an acceptable error range for the particular value should be assumed.

Casing and Packaging Materials

The present invention relates to packaging materials that can be made into various storage receptacles for use in holding lithium batteries, packaging or casings. The storage receptacle and method of manufacturer utilizes an admixture of hydrated amount of super absorbent polymer in an amount sufficient to extinguish a battery fire.

Battery fires present different and unique problems pertaining to how these fires should be extinguished and suppressed. While water is commonly employed to extinguish fires because it can quickly cool down the burning material, water does not necessary work on a battery fire especially since water may short circuit battery and/or operating device.

In the preferred embodiment of the present invention, an admixture of a super absorbent polymer and water is placed with a receptacle that stores a battery or a component that contains a battery. The aqueous admixture of the super absorbent polymer and water having properties which enable the super absorbent polymer and water admixture to be confined to a particular area because of its relatively high viscosity. The properties of the admixture, in particular its viscosity, enable the admixture to remain on vertical, horizontal, and curved surfaces formed by the receptacle. Unlike pure water, the admixture does not provide an electrically conductive path. The present invention adds a predetermined amount of the super absorbent polymer to a predetermined amount of water to obtain an admixture which has properties that enable the dissipation of heat and to suppress the spread of a battery fire and extinguish any fire that has attached itself to the individual. A ratio of about 4 grams of said super absorbent polymer is hydrated with about 0.1 gallons of water to suppress a lithium battery fire within the cavity. It is to be understood that the ratio of super absorbent polymer to water can vary to produce various physical states of the super absorbent polymer. For example, the viscosity can be adjusted to form a gel, slurry, liquid, semi-liquid, foam. In a preferred embodiment, the ratio of super absorbent polymer to water is adjusted to produce a gel. The gel itself can also vary in degrees of viscosity.

Accordingly, in one embodiment, a super absorbent aqueous based polymer is added to water in a dry weight from about 0.1 gram to about 100 kilograms wherein the volume of water ranges from about 0.1 liters to about 100 liters of water. In one preferred embodiment, a super absorbent aqueous based polymer is added to water in an amount effective to extinguish and suppress fire.

The admixture of Applicant's potassium based super absorbent polymer, marketed under the trademark FIREICE®, and water has physical and chemical properties which enable the admixture to entrap and retain the noxious and/or toxic gasses and prevent the release

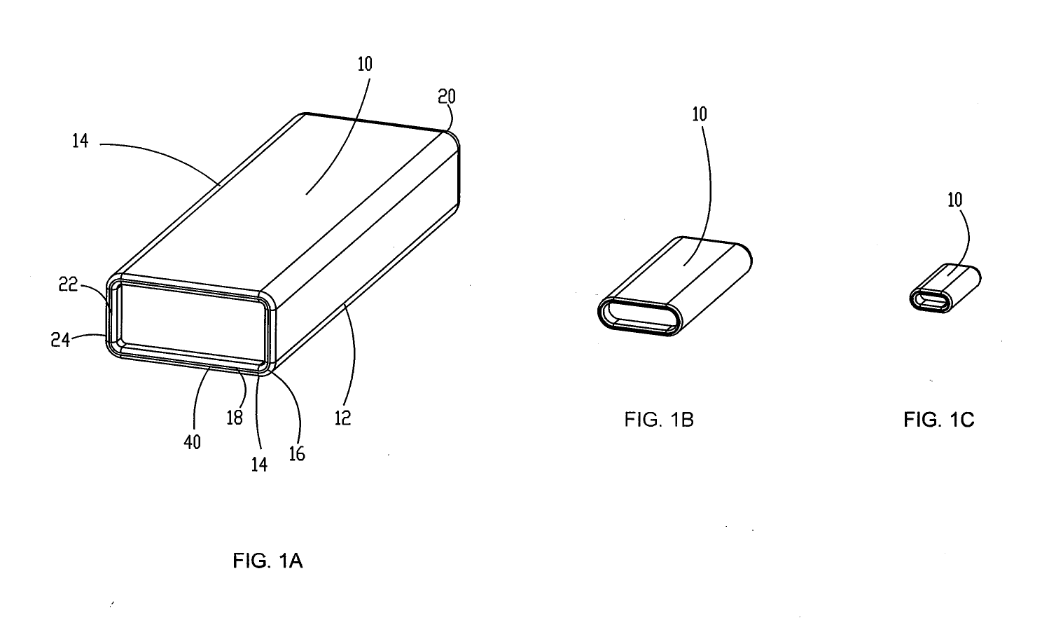

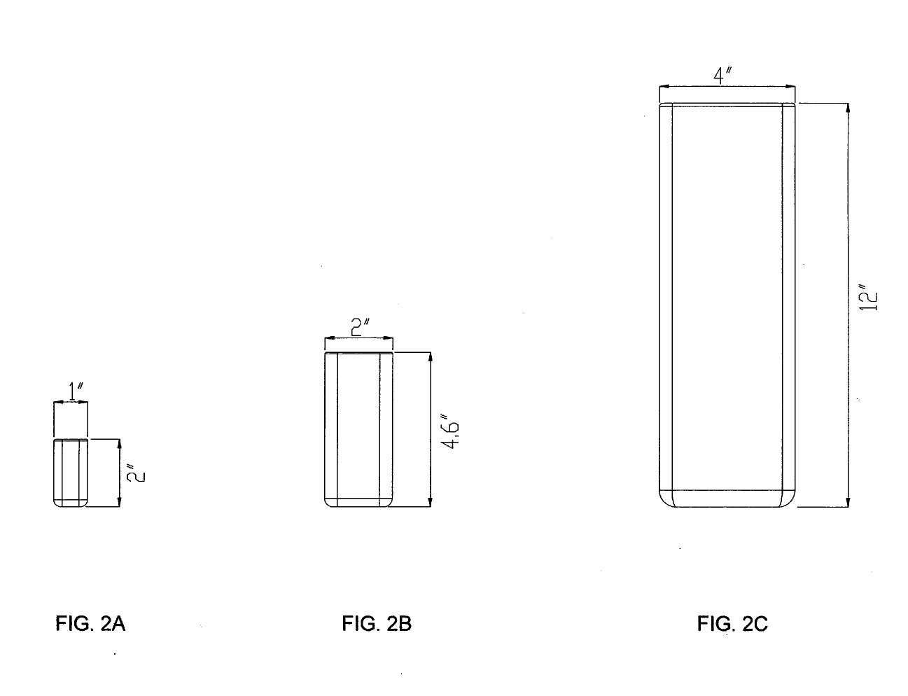

Referring now to FIGS. 1A-1C and 2A-2C, set forth is an exemplary embodiment of packaging used in the form of a fire suppressing storage receptacle for batteries is illustrated. A receptacle 10 is constructed from a first sidewall 12 spaced apart from a second sidewall 14 having a predetermined amount of super absorbent polymer 16 positioned therebetween. The sidewalls may assimilate a layered structure wherein the receptacle is formed from a material comprising: low density polypropylene, polypropylene, polyethylene, polyurethane, polyisoprene, plastics, or combinations thereof. The use of a flexible material is selected for its ability to be flexible and leak resistant with an ability to hold the hydrated material over a long period of time without evaporation. The admixture is a biodegradable, super absorbent, aqueous based cross linked modified polyacrylamides/potassium acrylate polymers. Other polymers may be used but not with the same quality level, examples of these polymers are cross-linked modified polyacrylamides/sodium acrylate, carboxy-methylcellulose, alginic acid, cross-linked starches, and cross-linked polyaminoacids.

The sidewalls 12, 14 are sealed along first and second end edges 18, 20 and first and second side edges 22, 24. Securement is by weldment, adhesive, or any other type of bonding, the securement forms a cavity opening 40 for which the batteries may be inserted. A sheet of non-woven polypropylene material can be placed between the two sheets to prevent gravity settling of the admixture. FIGS. 2A-2C is an example showing various dimensions of the pockets for use of varying size batteries. Should a stored battery overheat at least a portion of the receptacle will breach wherein the inner sidewall 12 will allow the hydrated polymer 16 to flow into the cavity 40 and address the overheated battery. It should be noted that the size of the cavity can be reduced for smaller batteries or enlarged to store items that house batteries such as phones, tablets, personal computers (PCs) or laptop computers.

The super absorbent polymer 16 is potassium based and hydrated at a level to make a non-conductive admixture. In particular the super absorbent polymer is an admixture of polyacrylamides/potassium acrylate marketed under the trademark FIREICE®. Unique to this admixture is the ability of the hydrated super absorbent polymer to suppress airborne organic compounds and airborne metals from an overheated battery.

Should the admixture leak, it will not affect any electrical component and clean-up can be performed by vacuuming the material once dried. Since the admixture of solid super absorbent polymer and water entraps the particulates and noxious and/or toxic gasses, the cleanup is substantially easier and quicker than the clean up from other methods of fire suppression and extinguishing.

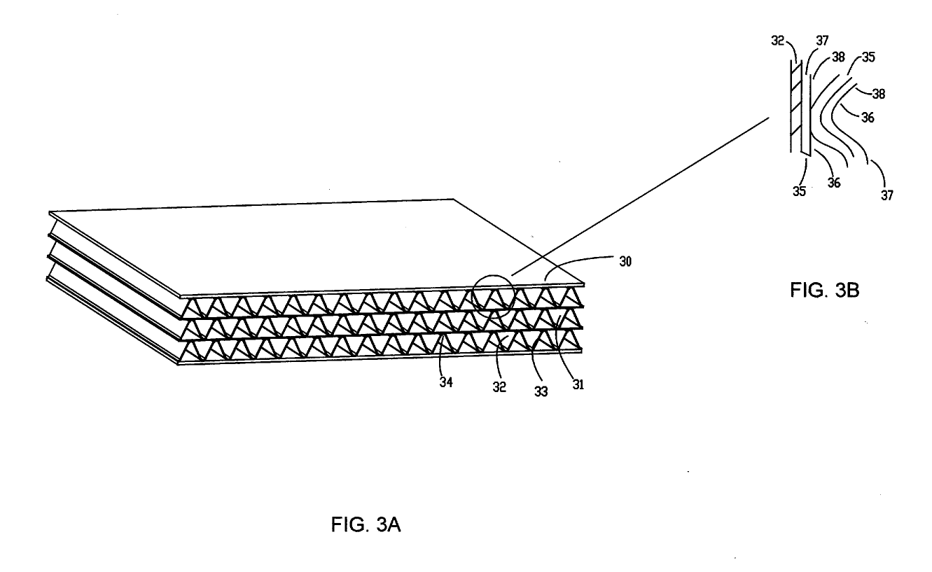

FIGS. 3A and 3B depicts a side 30 of a corrugated box comprising multiple layers of corrugations 31 separated by sheets 32. It is to be understood that the sides of the boxes can comprise any number of layers. In this depiction, the side comprises three layers of corrugations 31. The corrugations 31 are formed from undulations of ribs 33 which form the sides of the corrugations 31 and spines 34 which contact the sheets 32. In this embodiment, the sheets and/or layers can be lined with a waterproof or water-resistant material and the corrugations can be filled with the superabsorbent admixture. In other embodiments, the sheets and/or layers can be lined with a waterproof or water-resistant materials forming a first side 35 attached to the sheets 32 and corrugations 31. A second material forms a second side 36 thereby producing a cavity 37 for addition of the superabsorbent polymer. The liners 38 can be made of thin wall plastic encapsulating non-woven polypropylene material therebetween. The non-woven polypropylene is saturated with the hydrated admixture which prevents gravity settling. The admixture, which forms a gel, adheres to the non-woven polypropylene material to prevent settling when placed in a vertical position, such as along the sidewalls. In other embodiments, the cavity 37 between two liners 38 is filled with the super absorbent polymer admixture. In other embodiments the corrugations can also be filled with super absorbent polymer, or the interior walls of the package can be lined with a packaging material, similar to the lithium battery covers. The combinations of linings, fillings of cavities with the admixture are only limited by the imagination of the user.

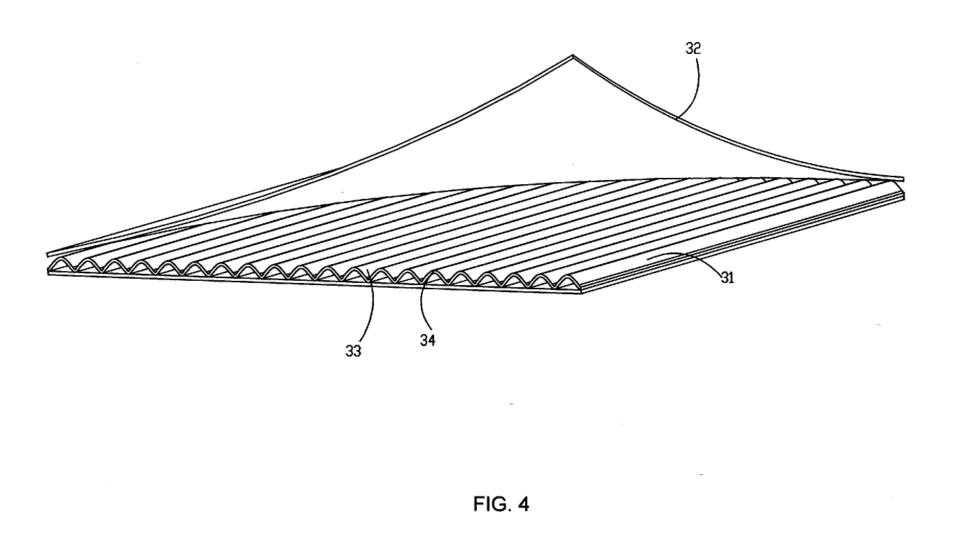

FIG. 4 depicts a side of a corrugated box with one layer of corrugations.

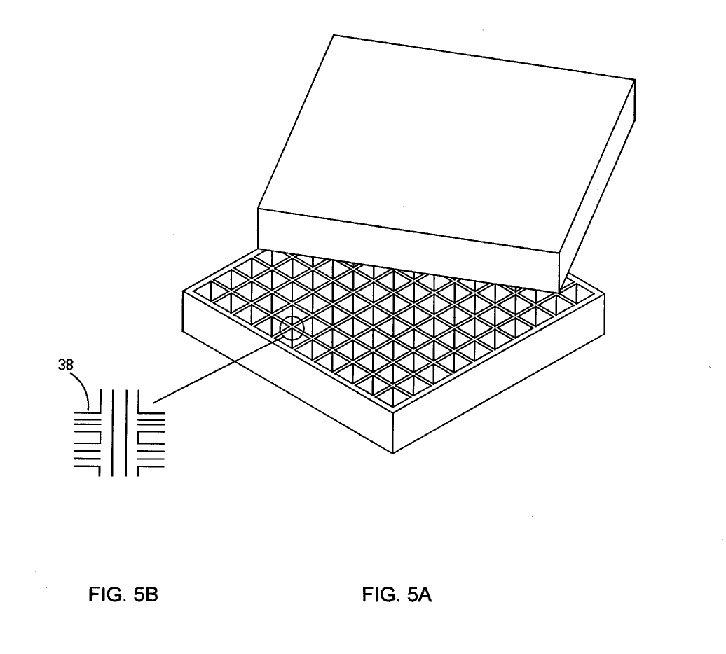

FIGS. 5A and 5B is another embodiment of packaging material which can be lined with packaging, shown by broken lines 38 comprising the super absorbent polymer admixture.

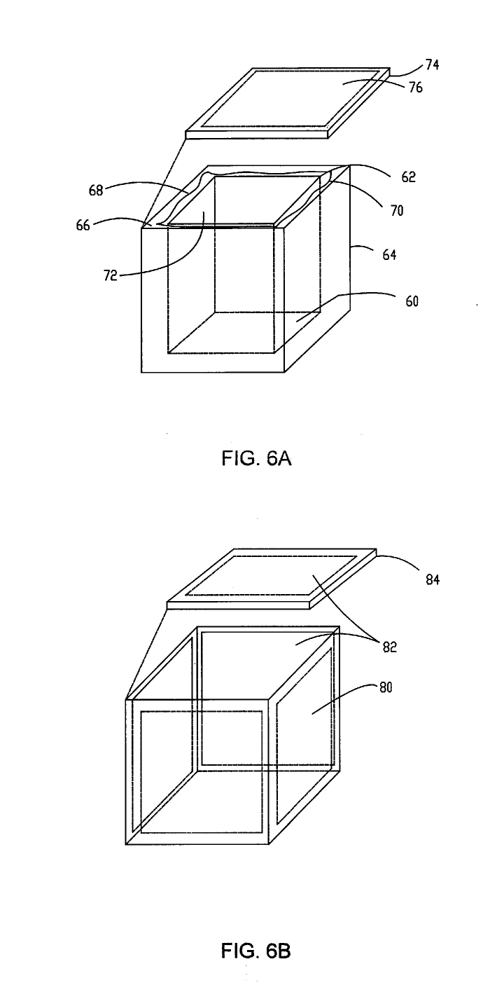

The corrugated box can also be a conventional box (FIG. 6A), having a box receptacle 72, outer sidewalls 64, inner sidewalls 62, a bottom wall 60, a lid 76 includes a liner 74. The inner sidewalls 62 and outer sidewalls 64 comprise a cavity 66 disposed therebetween wherein the cavity 66 is filled with the admixture 68, or alternatively comprises a liner filled with an admixture. (FIG. 6B), shows an alternative embodiment of a conventional box or bankers box having a box receptacle 80, sidewalls and a bottom wall. A lid 84 includes a liner 82 wherein files placed within the receptacle are surrounded by the admixture. In these configurations, should a fire occur, the heat from the fire will breach the thin wall plastic encapsulating the admixture. The admixture is exposed to saturate the fire, leading to extinguishment.

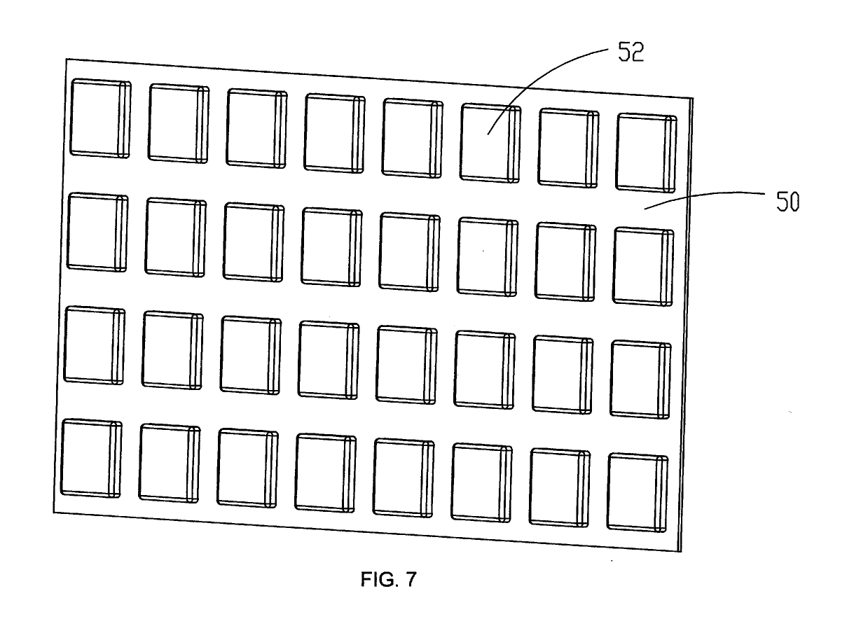

FIG. 7 depicts an alternative embodiment wherein the admixture is placed within a formation of gel packs. In this configuration, a flexible sheet of material 50 includes raised cavities 52 or gel packs 52 which may be uniform shaped or have at least one other shape positioned adjacent thereto. In this embodiment, each of the cavities 52 is filled with an admixture which operates as padding when the material is placed around any product, and provides fire protection when placed around a battery or the like device that is capable of catching fire. The configuration provides for a lightweight packaging material yet still provides fire protection to the batteries placed with the packing material. In operation, should a battery placed within the packing overheat, with or without an attendant fire, the heat causes the plastic to melt releasing the admixture directly onto the heat source. In particular, should a battery catch fire, the heat of the battery fire will cause the packaging to melt at the immediate area of the fire causing the release of the admixture for extinguishing the fire. The admixture will further adhere to the battery providing a cooling effect so as to suppress further arcing within the battery. The backing for the bubble wrap material may include a mesh or tin foil sheet that is capable of arresting small explosions. The mesh may be metal such as stainless steel wire, Kevlar, carbon fiber, basalt or the like material capable of containing small explosions such as a bursting battery. The flexible sheet of material 50 and mesh sheet, as well as the aforementioned dual sidewall construction, may be placed in most any shipping container as liners or simply used a wrapping material. For instance, the packaging sheet may be used as a liner for valuable machinery shipments, such as engines. In particular, the cost of aviation jet engines is extremely high and use of the packaging sheet can be used to protect the engine from fire during storage and shipping. It should be noted that having a fire suppression packaging position at the point of combustion serves to protect the remaining cargo. Another example is that of banker boxes uses for long term storage of paper files. The packaging of the instant invention is preferably used as a liner with the banker box providing close proximity to the paper files. The casings or shells for electronic equipment and components similarly function to protect against fires caused by a variety of sources such as batteries.

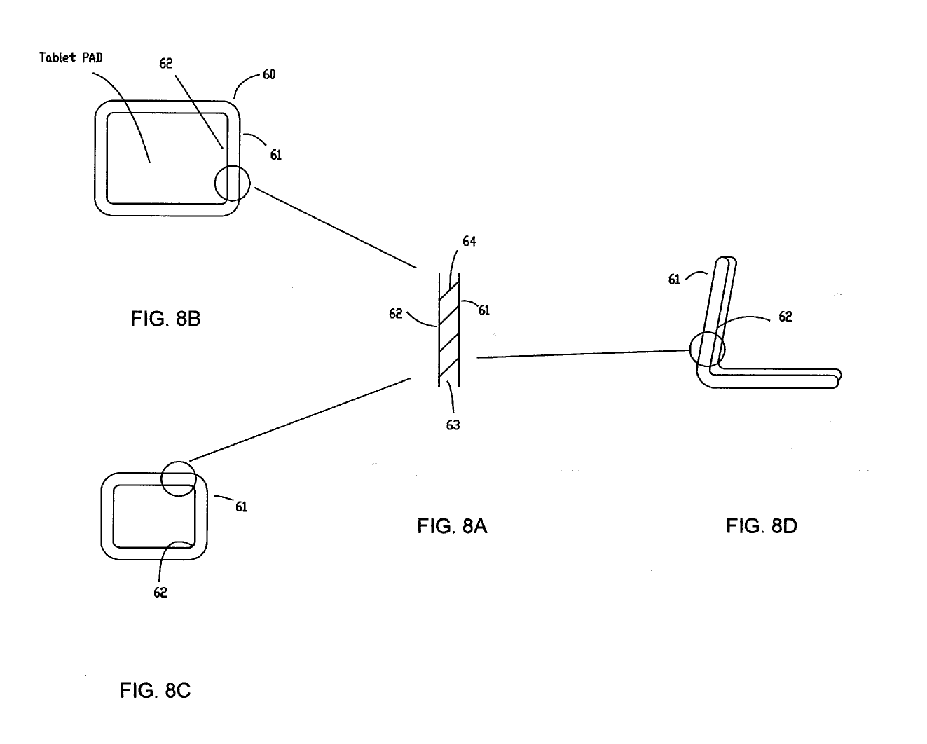

Referring to FIGS. 8A-8D, which depicts various casings or shells 60 for electronic equipment, e.g. tables, phones, laptops etc. The casing comprises an outer wall 61, an inner wall 62 forming a cavity 63 therebetween, wherein the cavity comprises the superabsorbent polymer admixture. The outer and inner walls 61, 62 can be produced from any type of material, flexible, semi-flexible, rigid etc., so as to provide protection from accidental breakage and/or leakage. In this embodiment, the inner wall 62 of the casing 60 melts if the electronic component heats up when, for example, the electronic component's lithium battery catches fire, releasing the admixture and extinguishing the fire. Due to the physical properties of the admixture, the admixture also acts as a heat sink or heat dissipater which helps in keeping the electronic component cool while it is on.

In other embodiments an insert for extinguishing and suppressing a fire comprises: a first sheet and a second sheet wherein said first and second sheets are sealed forming a cavity therebetween; a fire extinguishing admixture comprising a hydrated super absorbent polymer wherein said admixture is contained in said cavity, wherein heat breaches at least one sheet releasing said admixture to dissipate said heat or extinguish and suppress any fire production.

In some embodiments, the admixture is optionally contained in the cavity under positive or negative pressure. In this way, the contents will be expelled with some force when the insert walls of sheets are broken due to the heat of a flame. The insert can be flexible, semi-flexible, rigid or combinations thereof, for example, the first sheet is rigid and the second sheet is flexible allowing for the insert to be placed in a packaging container along the length and breadth of the container sides, while the flexible second sheet allows for expansion so as to contain large volumes of the admixture. The insert can optionally be adhered to a surface of a container. For example, the insert can be adhered to the inner walls of the packaging container or adhere to an object that is to be packaged. The first and second sheets can be sealable or resealable. For example, the inserts can be filled with the admixture at the point of packaging and sealed. Accordingly, in one embodiment, at least one edge is optionally resealable. The edges of the first and second sheets can be sealed by any method known in the art. For example, heat welding, glue, adhesion tape, or combinations thereof. The inserts can also be manufactured in any size, shape or conformation. In some embodiments, the insert is shaped and dimensioned depending on packaging container. The shapes and dimensions of the insert comprising: rods, squares, rectangles, triangles, spheres, cylinders, bubble wraps, packaging peanuts, sheets, or any combinations thereof.

In other embodiments, the first and second sheets are formed from materials comprising: low density polypropylene, polypropylene, polyesters, polyethylene, polyurethane, polyisoprene, plastics, elastomers, rubber-like resilient materials, silicone rubber, nitrile rubber, butyl rubber or combinations thereof.

In some embodiments, the fire suppressant or fire extinguishing composition is a biodegradable, super absorbent, aqueous based polymer. The fire extinguishing or fire suppressant can be any known or conventional fire suppressants, including biodegradable, super absorbent, aqueous based polymers. Examples of these polymers are cross-linked modified polyacrylamides/potassium acrylate or polyacrylamides/sodium acrylate. Other suitable polymers include, albeit not limited to, carboxy-methylcellulose, alginic acid, cross-linked starches, and cross-linked polyaminoacids. Examples of known fire suppressants include without limitation, those marketed under the brand name of FIREICE marketed by GelTech, Barricade II marketed by Barricade International; Thermo Gel 500p marketed by Thermo Industries; AFG Firewall marketed by NoChar; Phos-Chek, AquaGel-K, Focstop-K or Insul-8 marketed by ICL Performance Products; Blaze Tamer 380 marketed by Bio Central Labs; and Tetra KO marketed by Earth Clean Corporation. As used herein, a “fire suppressant” and “fire extinguishing” composition is used interchangeably and is meant to be inclusive of all components of the composition. In some embodiments, the fire extinguishing composition comprises one or more fire suppressant compounds. In other embodiments, the fire extinguishing composition comprises one or more common components of fire suppressant formulations, such as: fire suppressant salts, known or conventional fire suppressants, corrosion inhibitors, spoilage inhibitors, foaming agents, non foaming agents, flow conditioners, stability additives, thickening agents, pigments, dyes or the like.

The FIREICE® admixture is capable of suppressing harmful air emissions released from electrical files. A test of the admixture has been performed on electrical fires involving copper and aluminum cables.

### 1. Test Description

A total of five field test air sampling collections were undertaken on Jan. 18, 2011, at the High Current Laboratory (HCL) to evaluate the air emissions released from the application of Applicant's super absorbent polymer marked under the trademark FIREICE® to artificially induced faults generated using copper and aluminum cables. The five test scenarios were air sampled for airborne metals and organics. The description of the tests is given in Table 1.

TABLE 1
Test description

| Test # | Shot # | Test description | Cable description |
|---|---|---|---|
| 1 | 119 | New cables with copper conductor artificially | coned 500 kcmil Cu 600 V |
| | | faulted to create arc with no FIREICE ® added. | EAM/LSNH installed in |
| | | Target fault current: 2 kA. | coned precast concrete |
| | | Fault duration: until fault self-extinguished. | distribution box type B-3.6 |
| 2 | 120 | New cables with copper conductor artificially | coned 500 kcmil Cu 600 V |
| | | faulted to create arc with FIREICE ® added at | EAM/LSNH installed in |
| | | the on-set of arc. | coned precast concrete |
| | | Target fault current: 2 kA. | distribution box type B-3.6 |
| | | Fault duration: until fault self-extinguished. | |
| 3 | 121 | New cables with copper conductor artificially | coned 500 kcmil Cu 600 V |
| | | faulted to create arc with FIREICE ® added at | EAM/LSNH installed in |
| | | the on-set of arc - this was a repeat of test #2 | coned precast concrete |
| | | due to poor arc generation and non- | distribution box type B-3.6 |
| | | propagation of arc. | |
| | | Target fault current: 2 kA. | |
| | | Fault duration: until fault self-extinguished. | |
| 4 | 122 | New cables with aluminum conductor | coned 350 MCM Al 600 V |
| | | artificially faulted to create arc with FIREICE ® | EPR installed in coned |
| | | added at the on-set of arc. | precast concrete distribution |
| | | | box type B-3.6 |
| 5 | 123 | New cables with aluminum conductor | coned 350 MCM Al 600 V |
| | | artificially faulted to create arc with | EPR installed in coned |
| | | “FIREICE ®” added to concrete box to cover | precast concrete distribution |
| | | faulted cables prior to high current being | box type B-3.6 |
| | | applied to create arc. | |
| | | Target fault current: 2 kA. | |
| | | Fault duration: until fault self-extinguished. | |

In all the tests the cables were installed at the bottom of the concrete box, and the fault between the cables was created using a fuse wire. The approximate dimensions of the interior volume of the concrete box are: 33″×33″×24″. One calorimeter was installed above the concrete box to measure the incident energy generated by the fault.

The sampling equipment consisted of five separate sampling trains, each with a sampling pump drawing air through various air sampling components using a calibrated mass flow controller to maintain constant flow. The sampling time for each train was two minutes during each of the 5 arc test scenarios. For each sampling train a flow rate was selected based on the type of air sample being collected. The five sampling trains consisted of the following components and the air flow rate utilized:

1. A sampling train consisting of a MCE (mixed cellulose ester) filter in a cartridge filter holder for aerosol collection generated during the arc. The air flow rate through the filter was set to 1 L/min.

2. A sampling train for organic compounds using two Carbotrap™ 300 sampling tubes in series (front-back arrangement) was placed with the front sampling tube inlet at the edge of the concrete bunker. The air flow rate for the organics sampling tube train was 0.050 L/min.

3. A sampling train consisting of three impingers in series with 1M nitric acid in the first two impingers and an empty third impinger was used to trap airborne metals. The metals train air flow rate was set to 0.50 L/min.

4. A sampling train identical to the one described in 3 but with 0.5M KOH added to the first two impingers and an empty third impinger was setup plus an additional Carbotrap™ 300 organic compound sampling train as described in 2 was added in series to the outlet of the last impinger. The air sampling flow rate was set to 0.25 l/min for this train.

5. A final sampling train consisting of 3 impingers in series as described in 3 but with KOH added to the first two impingers and an empty third impinger to capture acidic species possibly generated during the FIREICE® tests. The air sampling flow rate was set to 0.25 L/min for this train.

### 2. Organic Compound Sampling Results—Carbotrap™ 300 Tube Analyses

The organic compounds released to air were captured using Carbotrap™ 300 tubes after the air sample passed through a KOH impinger train. The sampling flow rate was 0.25 L/min. The total mass of organic compounds collected during each of the five arc fault tests are given in Table 2. The organic compounds identified in the air samples are summarized in Table 3.

TABLE 2
Total Mass of Organic Compounds Collected on Carbotrap ™ 300
Sample Tubes and Estimated FIREICE ® Inhibition
Ratio for Organic Compound Release

| | | | Minimum |
|---|---|---|---|
| | | Total Mass of | Removal |
| | | Organics Collected | Efficiency |
| | | on Carbotrap ™ | Compared |
| Test Number & Description | | 300 Tubes (ng) | to Test 1 |
| 1 | Pair of New Neoprene Copper | 615 | — |
| | Cables - No FIREICE ® Applied | | |
| 2 | Pair of New Neoprene Jacketed | 189 | 3.2 |
| | Copper Cables - FIREICE ®- | | |
| | Added at On-Set of Arc | | |
| 3 | Pair of New Neoprene Jacketed | 138 | 4.5 |
| | Copper Cables - FIREICE ®- | | |
| | Added at On-Set of Arc (Repeat) | | |
| 4 | Pair of New Neoprene Jacketed | No Organic | >61.5* |
| | Aluminum Cables - FIREICE ® | Compounds | |
| | Added at On-Set of Arc | Detected | |
| 5 | Pair of New Neoprene Jacketed | No Organic | >61.5* |
| | Aluminum Cables - FIREICE ® | Compounds | |
| | Added Prior to Arc Generation | Detected | |

Note:
*Assumed minimum removal efficiency is assumed to be >61.5 as detection limit for any single organic compound is 10 ng.

TABLE 3
Organic Compounds Identified in High Flow Samples

| | | Organic Compounds Collected | |
|---|---|---|---|
| | | on Carbotrap ™ 300 Tubes | Total Organic |
| | | After Passage Through KOH | Compound Mass |
| Test Number & Description | | Impingers | (Front + Back) (ng) |
| 1 | Pair of New Neoprene Copper | ethane-1-chloro-1,1 difluoro* | 48000* |
| | Cables - No FIREICE ® Added | 2-butene, 2-methyl | 18 |
| | | 1,3-butadiene, 2-methyl | 40 |
| | | 1,3 pentadiene | 35 |
| | | 1,4 pentadiene | 14 |
| | | cyclopentane | 23 |
| | | 1-pentene, 2-methyl | 36 |
| | | benzene | 62 |
| | | 1,4-cyclohexadiene | 25 |
| | | 3-hexen-1-ol | 28 |
| | | toluene | 237 |
| | | ethylbenzene | 48 |
| | | styrene** | 2740** |
| | | a-methyl styrene** | 53** |
| 2 | Pair of New Neoprene Jacketed | ethane-1-chloro-1,1-difluoro | 68* |
| | Copper Cables - FIREICE ®- | 1,3-butadiene | 14 |
| | Added at On-Set of Arc | 1-pentene, 2-methyl | 21 |
| | | propane, 2-methyl-1-nitro | 31 |
| | | 3-heptene | 8 |
| | | benzene | 62 |
| | | butane, I-chloro-2-methyl | 25 |
| | | styrene** | 99** |
| | | unknown | 28 |
| 3 | Pair of New Neoprene Jacketed | ethane-1-chloro-1,1-difluoro | 264* |
| | Copper Cables - FIREICE ®- | 1-propene, 2-methyl | 16 |
| | Added at On-Set of Arc (Repeat) | 1,3-butadiene | 40 |
| | | 2-butene, 2-methyl | 12 |
| | | 1-pentene, 2-methyl | 25 |
| | | benzene | 34 |
| | | unknown | 11 |
| 4 | Pair of New Neoprene Jacketed | No organic compounds | 0 |
| | Aluminum Cables - FIREICE ® | detected on both front and back | |
| | Added at On-Set of Arc | Carbotrap ™ 300 tubes | |
| 5 | Pair of New Neoprene Jacketed | No organic compounds | 0 |
| | Aluminum Cables - FIREICE ® | identified on both front and back | |
| | Added Prior to Arc Generation | Carbotrap ™ 300 tubes | |

Notes:
*The ethane-1-chloro-1,1-difluoro is suspected to be contamination resulting from the partial decomposition of impinger train holder used during testing. The Freon HCFC 142b released during tests 1 to 3 is the trapped blowing agent used to make the closed cell foam. The foam was used to support and secure the impinger trains. Not included in organic compound mass reported.
**The styrene and a-methyl styrene are unintentional contaminants generated from the destruction of the aerosol filter holder used during the first arc fault Test-1. The filter- holder was too close to the arc-fault zone and did not survive Test-1. The styrene values are not included in organic compound mass reported.

### Direct Air Sampling

The total mass of organic compounds in the air samples collected directly on to Carbotrap™ 300 tubes during each of the five arc fault tests are given in Table 4. The organic compounds captured with the Carbotrap™ 300, tubes and subsequently detected during analysis are listed in Table 5. The sampling flow rate was 0.05 L/min.

TABLE 4
Total Mass of Organic Compounds on Direct Air
Sample onto Carbotrap ™ 300 Tubes
and FIREICE ® Inhibition Ratio

| | | Total Mass of | Minimum |
|---|---|---|---|
| | | Organics Collected | Removal |
| | | on. Carbotrap ™ | Efficiency |
| | | 300 Tubes (Front + | Compared |
| Test Number & Description | | Back) (ng) | to Test 1 |
| 1 | Pair of New Neoprene Jacketed | 158 | — |
| | Copper Cables - No FIREICE ® | | |
| 2 | Pair of New Neoprene Jacketed | 65 | 2.4 |
| | Copper Cables - FIREICE ®- | | |
| | Added at On-Set of Arc | | |
| 3 | Pair of New Neoprene Jacketed | 15 | >10 |
| | Copper Cables - FIREICE ®- | | |
| | Added at On-Set of Arc (Repeat) | | |
| 4 | Pair of New Neoprene Jacketed | None | >15.8 |
| | Aluminum Cables - FIREICE ® | Detected | |
| | Added at On-Set of Arc | | |
| 5 | Pair of New Neoprene Jacketed | 10 | 15.8 |
| | Aluminum Cables - FIREICE ® | | |
| | Added Prior to Arc Generation | | |

The total organic compound concentration measured directly with the Carbotrap™ 300 tubes associated with the copper cable arc fault in Test-1 is estimated to be 1.6 mg/m³ without the application of FIREICE®. For Test-2 through Test-5 the organic compound concentrations are estimated to be 0.6 mg/m³, 0.15 mg/m³, 0.0 mg/m³ and 0.1 mg/m³, respectively.

The FIREICE® application is effective in reducing organic emissions for both the copper cables and the aluminum cables. The removal efficiencies estimated in Table 2 and Table 4 compare well. The application of FIREICE® reduces organic emissions when applied with the arc fault is active. The presence of external contamination confirms the effective organic sampling in the vicinity of the arc fault during the five tests.

TABLE 5
Organic Compounds Identified in Direct Air Samples
Collected on Carbotrap ™ 300 Tubes

| | | Organic Compounds Collected | Organic Compound |
|---|---|---|---|
| Test Number &Description | | on Carbotrap ™ 300 Tubes | Mass (ng/tube) |
| 1 | Pair of New Neoprene Copper | Ethane-l-chloro-1,1 difluoro* | 53* |
| | Cables - No FIREICE ® Added | 1-pentene, 2-methyl | 15 |
| | | Benzene | 64 |
| | | toluene** | 41 |
| | | Styrene | 70 |
| | | methyl styrene** | 217* |
| | | isobutyl nitrile | 11 |
| | | propane, 2-methyl-1-nitro | 14 |
| | | unknown | 13 |
| 2 | Pair of New Neoprene Jacketed | 1-propene, 2-methyl | 8 |
| | Copper Cables - FIREICE ®- | 1,3 butadiene | 16 |
| | Added at On-Set of Arc | 2-butene, 2-methyl | 8 |
| | | 1-pentene, 2-methyl | 23 |
| | | unknown | 10 |
| 3 | Pair of New Neoprene Jacketed | 1-pentene, 2-methyl | 15 |
| | Copper Cables - FIREICE ®- | | |
| | Added at On-Set of Arc (Repeat) | | |
| 4 | Pair of New Neoprene Jacketed | No organic compounds | 0 |
| | Aluminum Cables - FIREICE ® | detected on both front and back | |
| | Added at On-Set of Arc | Carbotrap ™ 300 tubes | |
| 5 | Pair of New Neoprene Jacketed | No organic compounds | 0 |
| | Aluminum Cables - FIREICE ® | identified on both front and back | |
| | Added Prior to Arc Generation | Carbotrap ™ 300 tubes | 10 |
| | | Unknown peak (Front tube only) | |

Notes:
*The ethane-1-chloro-1,1-difluoro is suspected to be contamination resulting from the partial decomposition of impinger train holder used during testing. The Freon HCFC 142b released during testing is the trapped blowing agent used to make the closed cell foam. The foam was used to support and secure the impinger trains. The Freon was not included in organic compound mass reported.
**The styrene and a-methyl styrene are unintentional contaminants generated from the destruction of the aerosol filter holder used during the first arc fault Test-1. The filter- holder was too close to the arc-fault zone and did not survive Test-1. The styrene values are not included in organic compound mass reported.

TABLE 6
Metals Analysis Results (PPM) Filter
Pack Sampling ~2 m Above Arc Fault

| | Blank | Test 2 | Test 3 | Test 4 | Test 5 |
|---|---|---|---|---|---|
| Metal | (Avg) | (Cu) | (Cu) | (Al) | (Al) |
| Al | <0.5 | 3.15 | 6.81 | 1.48 | <0.5 |
| Ca | 2.15 | 1.80 | 4.96 | 2.52 | 1.93 |
| Cu | <1.5 | 94.8 | 312 | 1.98 | <1.5 |
| Fe | <0.25 | <0.25 | 2.85 | <0.25 | <0.25 |
| K | 67 | 68 | 39 | 28 | 23 |
| Mg | 0.19 | 8.4 | 18.9 | 0.25 | <0.1 |
| Na | <2.5 | <2.5 | 5.8 | <2.5 | <2.5 |
| P | <1 | <1 | 1.2 | <1 | <1 |
| S | <1 | <1 | 3.7 | <1 | <1 |
| Si | <1 | 4.3 | 20.5 | <1 | <1 |
| Ag | <0.005 | <0.005 | 0.007 | <0.005 | <0.005 |
| As | <0.05 | <0.05 | <0.05 | <0.05 | <0.05 |
| B | <0.05 | <0.05 | <0.05 | <0.05 | <0.05 |
| Ba | 0.007 | 0.012 | 0.022 | 0.008 | 0.006 |
| Bi | <0.005 | <0.005 | <0.005 | <0.005 | <0.005 |
| Be | <0.005 | <0.005 | <0.005 | <0.005 | <0.005 |
| Cd | <0.005 | <0.005 | <0.005 | <0.005 | <0.005 |
| Co | <0.005 | <0.005 | <0.005 | <0.005 | <0.005 |
| Cr | <0.005 | <0.005 | <0.005 | <0.005 | <0.005 |
| Cs | <0.005 | <0.005 | <0.005 | <0.005 | <0.005 |
| Li | <0.005 | <0.005 | 0.013 | <0.005 | <0.005 |
| Mn | 0.005 | 0.006 | 0.053 | 0.007 | 0.006 |
| Mo | <0.005 | <0.005 | <0.005 | <0.005 | <0.005 |
| Ni | 0.010 | 0.013 | 0.024 | 0.016 | 0.011 |
| Pb | <0.005 | 1.93 | 4.79 | 0.063 | 0.015 |
| Sb | 0.003 | 2.17 | 5.19 | 0.072 | 0.017 |
| Se | <0.05 | <0.05 | <0.05 | <0.05 | <0.05 |
| Sn | 0.029 | 0.036 | 0.028 | 0.006 | 0.005 |
| Sr | 0.007 | 0.006 | 0.028 | 0.009 | 0.006 |
| Th | <0.005 | <0.005 | <0.005 | <0.005 | <0.005 |
| Ti | 0.151 | 0.122 | 0.309 | 0.007 | 0.007 |
| Th | <0.005 | <0.005 | <0.005 | <0.005 | <0.005 |
| W | <0.005 | <0.005 | <0:005 | <0.005 | <0.005 |
| Zr | <0.005 | <0.005 | <0.005 | <0.005 | <0.005 |
| V | <0.05 | <0.05 | <0.05 | <0.05 | <0.05 |
| Zn | 0.037 | 1.22 | 3.02 | 0.054 | 0.042 |
| Hg | <0.005 | <0.005 | <0.005 | <0.005 | <0.005 |
| U | <0.005 | <0.005 | <0.005 | <0.005 | <0.005 |

TABLE 7
Metals Analysis Results (PPM) from Acid Impinger Sampler Train

| | | | | Test 3 | Test 4 | |
|---|---|---|---|---|---|---|
| Meta | MDL | Test I (Cu) | Test 2 | (Cu) | (Al) | Test 5 (Al) |
| Al | <0.01 | 0.145 | 0.272 | 0.330 | 0.328 | 0.640 |
| Ca | <0.01 | 0.485 | 1.30 | 0.388 | 0.523 | 0.094 |
| Cu | <0.01 | 0.22 | 0.918 | 0.816 | 0.66 | 0.062 |
| Fe | <0.005 | 0.02 | 0.056 | 0.023 | 0.028 | 0.025 |
| K | <0.01 | 1.24 | 0.896 | 0.644 | 77.8 | 13000 |
| Mg | <0.002 | 0.042 | 0.134 | 0.056 | 0.318 | 0.012 |
| Na | <0.05 | 0.951 | 0.727 | 1.78 | 0.905 | 10.5 |
| P | <0.02 | <0.02 | 0.049 | <0.02 | <0.02 | <0.02 |
| S | <0.05 | 0.043 | 0.070 | 0.099 | 0.043 | 0.504 |
| Si | <0.1 | 0.303 | 0.48 | 1.10 | 0.49 | 21.4 |
| Ag | <0.0001 | 0.004 | 0.005 | 0.004 | 0.005 | 0.002 |
| As | <0.001 | <0.001 | <0.001 | <0.001 | <0.001 | <0.001 |
| B | <0.025 | 0.853 | 0.638 | 1.61 | 0.922 | 2.88 |
| Ba | <0.0001 | 0.006 | 0.008 | 0.007 | 0.006 | 0.002 |
| Bi | <0.001 | <0.001 | <0.001 | <0.001 | <0.001 | <0.001 |
| Be | <0.001 | <0.001 | <0.001 | <0.001 | <0.001 | <0.001 |
| Cd | <0.0001 | <0.0001 | <0.0001 | <0.0001 | 0.0002 | <0.0001 |
| Co | <0.0001 | 0.0001 | 0.0004 | <0.0001 | 0.0002 | 0.0001 |
| Cr | <0.0001 | 0.0007 | 0.0009 | 0.0006 | 0.0006 | 0.019 |
| Cs | <0.0001 | <0.0001 | <0.0001 | <0.0001 | 0.002 | 0.819 |
| Li | <0.001 | <0.001 | <0.001 | <0.001 | <0.001 | 0.004 |
| Mn | <0.0001 | 0.001 | 0.002 | 0.0006 | 0.0010 | 0.015 |
| Mo | <0.0001 | 0.0002 | 0.0002 | 0.0003 | 0.0002 | 0.0020 |
| Ni | <0.0001 | 0.002 | 0.001 | 0.002 | 0.002 | 0.001 |
| Pb | <0.0001 | 0.003 | 0.003 | 0.008 | 0.009 | 0.008 |
| Sb | <0.001 | 0.002 | 0.002 | 0.007 | 0.003 | <0.001 |
| Se | <0.001 | <0.001 | <0.001 | <0.001 | <0.001 | 0.004 |
| Sn | <0.0001 | 0.0004 | 0.0003 | 0.0002 | 0.0005 | 0.0020 |
| Sr | <0.0001 | 0.002 | 0.005 | 0.002 | 0.003 | 0.001 |
| Th | <0.0001 | <0.0001 | <0.0001 | <0.0001 | <0.0001 | <0.0001 |
| Ti | <0.0001 | 0.001 | 0.004 | 0.002 | 0.002 | 0.014 |
| TI | <0.0001 | <0.0001 | <0.0001 | <0.0001 | <0.0001 | <0.0001 |
| W | <0.0001 | <0.0001 | <0.0001 | <0.0001 | 0.0001 | 0.037 |
| Zr | <0.0001 | 0.0002 | 0.0008 | 0.0007 | 0.0007 | 0.027 |
| V | <0.0001 | <0.0001 | <0.0001 | <0.0001 | <0.0001 | 0.0002 |
| Zn | <0.0001 | 0.01 | 0.009 | 0.01 | 0.021 | 0.003 |
| Hg | <0.0001 | <0.0001 | <0.0001 | <0.0001 | <0.0001 | <0.0001 |
| U | <0.0001 | <0.0001 | <0.0001 | <0.0001 | <0.0001 | <0.0001 |

A 2-liter air sample was taken through a filter pack at about 2 meters above each arc test. Each available exposed filter was analyzed for metals and other elements. The results for 38 element analyses are presented in Table 6.

Some key observations are noted from filter analysis for the Test-2 through Test-5 data available in Table 6: A key result noted is the below detection of aluminum for Test 5 compared to a measurable detection in Test 4. Both tests used new aluminum cables for the arc fault but in the Test 5 case the fault zone was encapsulated in FIREICE® prior to arc fault generation whereas for Test 4 the arc fault was initiated into air and then FIREICE® was added to quench the arc fault. The lead (Pb), antimony (Sb), magnesium (Mg), copper (Cu), and calcium (Ca) results add confirmation to the reduction of released metals with the arc fault encapsulated.

The counter ion for FIREICE® is potassium (K). For all four arc fault tests, the filter analysis did not detect potassium above the nominal background concentration of potassium present on the filter prior to exposure. This is evidence that FIREICE® did not undergo detectable degradation during the arc faults where FIREICE® was applied.

Test 2 and Test 3 were essentially duplicate tests using new neoprene jacketed copper cables for the arc fault with Test 3 having the more sustained arc fault. The procedure for applying FIREICE® was the same for both tests. At the on-set of the arc fault the addition of FIREICE® was begun and continued until the concrete cell was about ½ full. For the more sustained arc fault (Test 3) the key metals from the vaporized copper cable as measured with the filter pack were about 3 to 4 times higher than the metals released in the much shorter arc period of Test 2. Key metals released were aluminum (1.7%), copper (80%), magnesium (4.8%), zinc (0.8%), lead (1.2%), calcium (1.3%) and antimony (1.3%) with remaining components at <1% to only present at trace levels.

The estimated airborne total metals concentration for Test 3 is 0.17 g/m³ and for Test 2 is 0.058 g/m³. Similarly for the aluminum cables the estimated airborne total metals concentration for Test 4 is 0.003 g/m³ and for Test 5 is 0.001 g/m³.

For comparison the Ontario Ministry of Labor time-weighted average exposure concentration (TWAEC) for a variety of fumes and particulate, ranges from 0.003 to 0.01 g/m³ for 40-hr work week and for short term exposures, the particulate concentrations range from 0.005 to 0.02 g/m³ for a maximum 15 minute continuous exposure depending on the fume and particulate present.

Observations from the metals train analysis for Tests 1 through 5 are summarized below and are based on the metal/element analysis data present in Table 7.

The high level of potassium in the Test 5 results were from the entrainment of airborne FIREICE® into the first impinger as the arc generated gas that ejected some of the FIREICE® material into the air. This is confirmed by the increase in silica, sodium and sulfur.

For Test 4 a significant level of copper (0.66 ppm) is measured as copper residue from Tests 1 to 3 is released during the aluminum cable arc fault. However in Test 5 very little copper is detected (>10× less detected 0.062 ppm) with the FIREICE® encapsulating the arc fault zone. This also confirmed by the similar reduction in magnesium detected.

The impinger samples collected similar amounts of metals for the copper cable arc fault tests. The metal concentration levels were and are given in Table 7.

The application of FIREICE® to neoprene jacketed copper and aluminum cables is effective in reducing airborne organic compounds and also airborne metals. Removal efficiencies from 2 times to greater than 15 times can be expected when added to an active arc fault. For a FIREICE® encapsulated arc fault greater than 60 times removal of metals and arc generated arc products is possible based on the five tests performed. The optimum admixture is ratio of 100 grams of FIREICE to 2.5 gallons of clean clear water.

The method of manufacturing a fire suppressing receptacle for lithium batteries comprises: forming a first rectangular shaped sidewall from flexible plastic, said first sidewall having a first longitudinal side edge spaced apart from a second longitudinal side edge extending between said first and second end edges; forming a second rectangular shaped sidewall from flexible plastic, said second sidewall forming a mirror image of said first sidewall; securing at least two side edges of said first and second shaped sidewall together forming a first cavity; inserting an admixture of hydrated super absorbent polymer into said first cavity and sealing said first cavity; and securing at least a portion of each side edge together forming a second cavity; wherein a lithium battery is insertable into the second cavity whereby a lithium battery breach will rupture the sidewall forming said second cavity allowing the admixture to flow to the lithium battery breach. The method includes a releasable seal placed in the second open end for sealing at least one battery within said cavity. The releasable seal can be adhesive tape or a hook and loop attachment.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

1. A fire suppressing and fire extinguishing packaging comprising:
a first sidewall defined by a flexible sheet of material having first and second end edges and first and second longitudinal side edges secured to a second sidewall having a mirror image of the first sidewall forming a space therebetween;
a fire extinguishing admixture comprising a hydrated super absorbent polymer wherein said admixture is contained in said space, wherein heat breaches at least one sidewall releasing said admixture to dissipate said heat or extinguish and suppress any fire production.

2. The fire suppressing and fire extinguishing packaging of claim 1, wherein said admixture is potassium based and non-conductive when hydrated.

3. The fire suppressing and fire extinguishing packaging of claim 2, wherein said admixture is in a ratio of about 1 gram of said super absorbent polymer hydrated with about 0.4 liters of water to extinguish and suppress a fire.

4. The fire suppressing and fire extinguishing packaging of claim 2, wherein said admixture is in a ratio of about 4 grams of said super absorbent polymer hydrated with about 0.4 liters of water to extinguish and suppress a fire.

5. The fire suppressing and fire extinguishing packaging of claim 1, wherein said first and second walls are formed from materials comprising: low density polypropylene, polypropylene, polyesters, polyethylene, polyurethane, polyisoprene, plastics, elastomers, rubber-like resilient materials, silicone rubber, nitrile rubber, butyl rubber or combinations thereof.

6. The fire suppressing and fire extinguishing packaging of claim 1, further comprising a mesh constructed and arranged to suppress a battery explosion with said cavity wherein the mesh comprises steel wire, Kevlar, carbon fiber, or basalt.

7. The fire suppressing and fire extinguishing packaging of claim 1, wherein said super absorbent polymer is hydrated at a level to suppress airborne organic compounds and airborne metals from an overheated battery.

8. The fire suppressing and fire extinguishing packaging of claim 1, wherein said super absorbent polymer is an admixture of polyacrylamides/potassium acrylate.

9. An insert for extinguishing and suppressing a fire comprising: a first sheet and a second sheet wherein said first and second sheets are sealed forming a cavity therebetween;
a fire extinguishing admixture comprising a hydrated super absorbent polymer wherein said admixture is contained in said cavity, wherein heat breaches at least one sheet releasing said admixture to dissipate said heat or extinguish and suppress any fire production.

10. The insert of claim 9, wherein said admixture is optionally contained in said cavity under positive or negative pressure.

11. The insert of claim 9, wherein said first and second sheets are flexible, semi-flexible, rigid or combinations thereof.

12. The insert of claim 9, wherein said first or second sheets are optionally adhered to a surface of a container.

13. The insert of claim 9, wherein each edge of said first and second sheets is sealable or resealable.

14. The insert of claim 13, wherein at least one edge is optionally resealable.

15. The insert of claim 13, wherein said edges are sealed by heat welding, glue, adhesion tape, or combinations thereof.

16. The insert of claim 9, wherein said insert is shaped and dimensioned depending on packaging container said shapes and dimensions comprising: rods, squares, rectangles, triangles, spheres, cylinders, bubble wraps, packaging peanuts, sheets, or any combinations thereof.

17. The insert of claim 9, wherein said super absorbent polymer is an admixture of polyacrylamides/potassium acrylate.

18. The insert of claim 9, wherein said first and second sheets are formed from materials comprising: low density polypropylene, polypropylene, polyesters, polyethylene, polyurethane, polyisoprene, plastics, elastomers, rubber-like resilient materials, silicone rubber, nitrile rubber, butyl rubber or combinations thereof.
